(19) United States
(12) Patent Application Publication
(10) Pub. No.: US 2011/0150719 A1
(43) Pub. Date: Jun. 23, 2011

(54) MICROWAVE INTRODUCTION MECHANISM, MICROWAVE PLASMA SOURCE AND MICROWAVE PLASMA PROCESSING APPARATUS

(75) Inventor: Taro Ikeda, Yamanashi-Ken (JP)

(73) Assignee: TOKYO ELECTRON LIMITED, Tokyo-To (JP)

(21) Appl. No.: 13/059,680

(22) PCT Filed: Aug. 21, 2009
(86) PCT No.: PCT/JP2009/064663

§ 371 Date: Feb. 18, 2011

(51) Int. Cl. B01J 19/08; H01Q 13/18

(52) U.S. Cl. 422/186; 343/781 R

(57) ABSTRACT

A microwave introduction mechanism (43) includes: an antenna section (45) including a plane antenna (54) for radiating microwaves into a chamber (1); a coaxial tube (50) connected to the plane antenna (54) to guide microwaves to the plane antenna (54); and a tuner section (44) provided in the coaxial tube (50) for impedance adjustment. The plane antenna (54) has a plurality of arc-shaped slots (54a) for radiating microwaves, formed such that, assuming that a plurality of imaginary concentric circles, arranged at a spacing equal to an integral multiple of “λg/4+δ” (wherein λg represents the effective wavelength of microwaves, and δ is a value that falls within the range 0≦δ≦0.05λg), are drawn on a plane of the plane antenna, “n” (n is an integer not less than 2) arc-shaped slots having the same length are evenly arranged on each imaginary circle, and the plurality of arc-shaped slots form “n” groups where the slots belonging to each group arranged in a radial direction and have the same central angle and the same angular position.

### TECHNICAL FIELD

The present invention relates to a microwave introduction mechanism for introducing microwaves into a chamber for plasma processing, and to a microwave plasma source and a microwave plasma processing apparatus which use the microwave plasma introduction mechanism.

### BACKGROUND ART

Plasma processing is an essential technology for the production of semiconductor devices. Responding to the recent demand for more highly integrated, higher-speed LSIs, design rules for semiconductor devices which constitute an LSI are becoming increasingly finer. On the other hand, semiconductor wafers have recently become larger in scale. A demand therefore exists for a plasma processing apparatus which can sufficiently treat fine semiconductor devices and large wafers.

Parallel plate-type or inductively-coupled-type plasma processing apparatuses, which have conventionally been used frequently, may cause plasma damage to fine semiconductor devices due to the high electron temperature of the plasma. In addition, because of a limited high-density plasma region, it is difficult for such plasma processing apparatuses to process a large-sized semiconductor wafer uniformly at a high processing rate.

Attention has therefore been drawn to an RLSA (radial line slot antenna) microwave plasma processing apparatus which can uniformly form a high-density, low-electron temperature plasma (see e.g. Japanese Patent Laid-Open Publication No. 2000-294550).

An RLSA microwave plasma processing apparatus includes a plane antenna (radial line slot antenna), having a large number of slots formed in a predetermined pattern, disposed at the top of a chamber. Microwaves from a microwave source are radiated from the slots of the plane antenna into the chamber, which is kept under vacuum, via a microwave transmissive plate of dielectric material, provided under the plane antenna. A gas, introduced into the chamber, is turned into plasma by the microwave electric field so that a processing object, such as a semiconductor wafer, is processed with the plasma.

Conventional RLSA microwave plasma processing apparatuses generate microwaves by means of a magnetron whose output port has the shape of a rectangular waveguide. On the other hand, mode conversion from the rectangular waveguide into a coaxial waveguide is necessary to transmit microwaves to a slot antenna. Parts, such as a mode converter, are therefore interposed between the magnetron and an antenna section. Such an RLSA microwave plasma processing apparatus needs to use an impedance matching section (tuner) for matching of load impedance. Because of the necessity of a certain area (length and width) for mounting of an impedance matching section, it is generally provided in a rectangular waveguide which also has the advantage of smaller power loss per unit length as compared to a coaxial waveguide. Parts, such as a mode converter, are therefore interposed between the antenna section and the impedance matching section.

In such a structure, a standing wave will occur between the antenna and the impedance matching section upon impedance matching, leading to power dissipation between the antenna and the impedance matching section. The degree of the power dissipation is proportional to the distance between the antenna and the impedance matching section. Thus, in order to minimize the power loss, it is necessary to shorten the distance between the antenna and the impedance matching section as much as possible. In the conventional construction, however, the distance should necessarily be long because of the provision of parts, such as a mode converter, between the antenna and the impedance matching section. The power dissipation exerts a great influence especially on a large diameter antenna which is currently used in response to the recent change to larger diameter semiconductor wafer. In particular, the occurrence of a power dissipation between a large diameter antenna and an impedance matching section lowers the efficiency of power transmission to the antenna and the loading region (plasma), making it difficult to supply a sufficient power from the large diameter antenna.

Further, in the case of a large diameter antenna, the antenna itself cannot always supply electric power efficiently to a plasma-forming space. Furthermore, the supply of electric power cannot be performed with good uniformity. In addition, power dissipation between the antenna and an impedance matching section generates a considerable amount of heat in the power dissipation region, which necessitates a cooling mechanism for adequately cooling the region.

### DISCLOSURE OF THE INVENTION

It is therefore an object of the present invention to provide a microwave introduction mechanism which can supply electric power to an antenna and a loading region (plasma) with high transmission efficiency and high uniformity even when the antenna is a large diameter antenna, and to provide a microwave plasma source and a microwave plasma processing apparatus which both use the microwave introduction mechanism.

In a first aspect, the present invention provides a microwave introduction mechanism for introducing microwaves, outputted from a microwave output section, into a chamber and for use in a microwave plasma source for forming microwaves in the chamber, comprising: an antenna section including a plane antenna for radiating microwaves into the chamber; a microwave transmitting member having a coaxial structure, connected to the plane antenna, for guiding microwaves to the plane antenna; and an impedance adjustment section, provided in the microwave transmitting member, for performing impedance adjustment, wherein the impedance adjustment section includes a pair of slugs of dielectric material which are movable along the microwave transmitting member, and wherein the plane antenna has a plurality of arc-shaped slots for radiating microwaves, formed such that, assuming that a plurality of imaginary concentric circles, arranged at a spacing equal to an integral multiple of “λg/4+δ” (wherein λg represents the effective wavelength of microwaves, and δ is a value that falls within the range 0≦δ≦0.05λg), are drawn on a plane of the plane antenna, “n” (n is an integer not less than 2) arc-shaped slots having the same length are evenly arranged on each imaginary circle, and the plurality of arc-shaped slots form “n” groups where the slots belonging to each group arranged in a radial direction and have the same central angle and the same angular position.

In the first aspect of the present invention, the antenna section preferably includes a ceiling plate of dielectric material which is transmissive to microwaves radiated from the antenna, and a retardation member of dielectric material, provided on the opposite side of the antenna from the ceiling plate, for shortening the wavelength of microwaves which are to reach the antenna. The microwave transmitting member preferably has a microwave transmission path whose size is adjusted to transmit only TEM waves without transmitting TE waves and TM waves. In this case, the microwave transmitting member may include a cylindrical or rod-like inner conductor connected to the plane antenna, and a cylindrical outer conductor concentrically provided outside the inner conductor, with the microwave transmission path being formed between the inner conductor and the outer conductor.

Preferably, the microwave introduction mechanism further comprises a power diffusing member provided at the joint between the inner conductor and the plane antenna. The plane antenna is preferably configured such that electromagnetic waves are transmitted from the center toward the periphery of the plane antenna by the mutual induction effect of a magnetic field induced by TM01 waves. The impedance adjustment section and the antenna preferably function as a resonator.

In a second aspect, the present invention provides a microwave plasma source for introducing microwaves into a chamber to turn a gas, supplied into the chamber, into plasma, comprising a microwave generation mechanism for generating microwaves and a microwave introduction mechanism for introducing the generated microwaves into the chamber, wherein the above-described microwave introduction mechanism according to the first aspect is used as said microwave introduction mechanism.

In a third aspect, the present invention provides a microwave plasma processing apparatus comprising a chamber for housing the substrate, a gas supply mechanism for supplying a gas into the chamber, and a microwave plasma source for introducing microwaves into the chamber to turn the gas, supplied into the chamber, into a plasma, the microwave plasma source including a microwave generation mechanism for generating microwaves and a microwave introduction mechanism for introducing the generated microwaves into the chamber, said microwave plasma processing apparatus being configured to processing a substrate with the plasma in the chamber, wherein the above-described microwave introduction mechanism according to the first aspect is used as said microwave introduction mechanism.

### BRIEF DESCRIPTION OF THE DRAWINGS

FIG. 1 is a cross-sectional diagram showing the schematic construction of a plasma processing apparatus provided with a microwave plasma source having a microwave introduction mechanism according to an embodiment of the present invention;

FIG. 2 is a configuration diagram showing the construction of the microwave plasma source of FIG. 1;

FIG. 3 is a diagram showing an exemplary circuit construction of a main amplifier;

FIG. 4 is a cross-sectional diagram showing the microwave introduction mechanism of the microwave plasma processing apparatus of FIG. 1;

FIG. 5 is a plan view showing a plane antenna provided in the microwave introduction mechanism of FIG. 4;

FIG. 6 is a schematic diagram illustrating transmission of microwaves in the plane antenna;

FIG. 7 is a schematic diagram illustrating the principle of enhancement of a standing wave in the plane antenna;

FIG. 8 is a cross-sectional diagram showing a microwave introduction mechanism according to another embodiment of the present invention; and

FIG. 9 is a schematic diagram showing a specific example of the design of a microwave introduction mechanism according to the present invention.

### EMBODIMENTS FOR CARRYING OUT THE INVENTION

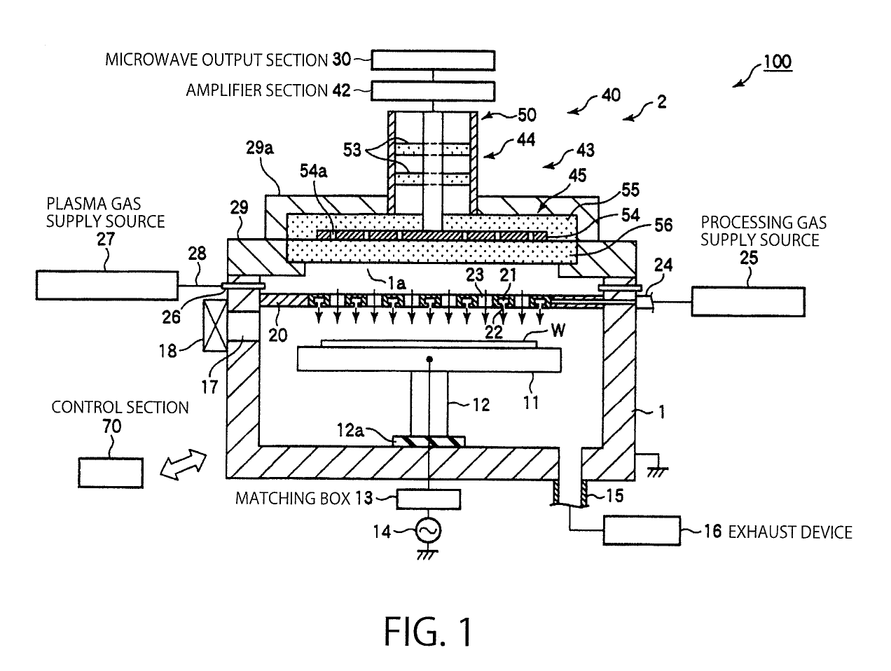

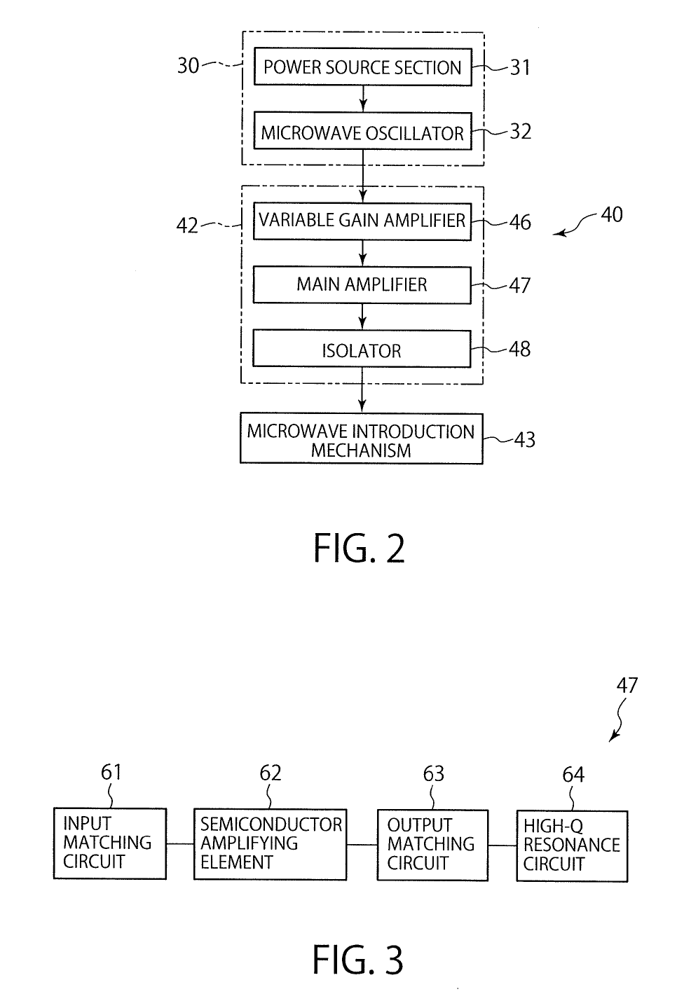

Preferred embodiments of the present invention will now be described in detail with reference to the drawings. FIG. 1 is a cross-sectional diagram showing the schematic construction of a plasma processing apparatus provided with a microwave plasma source according to an embodiment of the present invention; and FIG. 2 is a configuration diagram showing the construction of the microwave plasma source of FIG. 1.

The plasma processing apparatus 100 is constructed e.g. as a plasma etching apparatus for carrying out etching of a wafer with a plasma, and includes a generally-cylindrical airtight and grounded chamber 1 made of a metal material, such as aluminum or stainless steel, and a microwave plasma source 2 for forming a microwave plasma in the chamber 1. The chamber 1 has a top opening 1a, and the microwave plasma source 2 is disposed such that it faces the interior of the chamber 1 at the opening 1a.

In the chamber 1 is provided a susceptor 11 for horizontally supporting a semiconductor wafer W as a processing object. The susceptor 11 is supported by a cylindrical support member 12 which is vertically mounted via an insulating member 12a on the center of the bottom of the chamber 1. Aluminum which has been subjected to alumite surface processing (anodizing), for example, may be used as a material for the susceptor 11 and the support member 12.

Though not depicted, the susceptor 11 is provided with an electrostatic chuck for electrostatically attracting the wafer W, a temperature control mechanism, a gas flow passage for supplying a heat-conducting gas to the back surface of the wafer W, lifting pins which move up and down for transport of the wafer W, etc. A high-frequency bias power source 14 is electrically connected via a matching box 13 to the susceptor 11. Ions are drawn toward the wafer W by supplying a high-frequency power from the high-frequency bias power source 14 to the susceptor 11.

An exhaust pipe 15 is connected to the bottom of the chamber 1, and to the exhaust pipe 15 is connected an exhaust device 16 including a vacuum pump. By the actuation of the exhaust device 16, the chamber 1 can be quickly evacuated and depressurized into a predetermined vacuum. The side wall of the chamber 1 is provided with a transfer port 17 for carrying the wafer W into and out of the chamber 1, and a gate valve 18 for opening and closing the transfer port 17.

A shower plate 20 for ejecting a processing gas for plasma etching toward the wafer W is disposed horizontally in the chamber 1 in a position above the susceptor 11. The shower plate 20 includes a grid-like gas flow passage 21, and a large number of gas ejection holes 22 formed in the gas flow passage 21, with space portions 23 being defined by the grid-like gas flow passage 21. To the gas flow passage 21 of the shower plate 20 is connected piping 24 extending outwardly from the chamber 1, and to the piping 24 is connected a processing gas supply source 25.

A ring-shaped plasma gas introduction member 26, having a large number of gas ejection holes in the inner periphery, is provided along the chamber wall in a position above the shower plate 20. A plasma gas supply source 27 for supplying a plasma gas is connected via piping 28 to the plasma gas introduction member 26. A rare gas, such as Ar gas, is preferably used as the plasma gas.

The plasma gas, introduced from the plasma gas introduction member 26 into the chamber 1, is turned into plasma by microwaves introduced from the microwave plasma source 2 into the chamber 1. The plasma passes through the space portions 23 of the shower plate 20, and excites the processing gas ejected from the gas ejection holes 22 of the shower plate 20, thereby forming a plasma of the processing gas.

The microwave plasma source 2 is supported by a support ring 29 provided on the top of the chamber 1, with the interface between them being hermetically sealed. As shown in FIG. 2, the microwave plasma source 2 includes a microwave output section 30 for outputting microwaves, and an antenna unit 40 for introducing and radiating the microwaves, outputted from the microwave output section 30, into the chamber 1.

As shown in FIG. 2, the microwave output section 30 includes a power source section 31 and a microwave oscillator 32. The microwave oscillator 32 generates microwaves having a predetermined frequency (e.g. 2.45 GHz) e.g. by PLL oscillation. Besides 2.45 GHz, other frequencies such as 8.35 GHz, 5.8 GHz, 1.98 GHz, etc., can also be used as a microwave frequency.

The antenna unit 40 includes an amplifier section 42 for mainly amplifying microwaves, and a microwave introduction mechanism 43. The microwave introduction mechanism 43 includes a tuner section 44 having a tuner for impedance matching, and an antenna section 45 for radiating the amplified microwaves into the chamber 1. An upper portion of the antenna section 45 is covered with a conductor cover 29a.

The amplifier section 42 includes a variable gain amplifier 46, a main amplifier 47 constituting a solid-state amplifier, and an isolator 48.

The variable gain amplifier 46 is an amplifier for adjusting the power level of microwaves to be inputted into the main amplifier 47 and thereby adjusting the intensity of plasma.

As shown in FIG. 3, the main amplifier 47, constituting a solid-state amplifier, may be comprised of an input matching circuit 61, a semiconductor amplifying element 62, an output matching circuit 63, and a high-Q resonance circuit 64. GaAsHEMT, GaNHEMT or LD-MOS, which is capable of Class E operation, can be used as the semiconductor amplifying element 62. In particular, when GaNHEMT is used as the semiconductor amplifying element 62, power control is performed at a constant value of the variable gain amplifier and at a variable power-supply voltage of the Class E operation amplifier.

The isolator 48, which is to isolate reflected microwaves which have been reflected from the antenna section 45 and travel toward the main amplifier 47, includes a circulator and a dummy load (coaxial terminator). The circulator guides the reflected microwaves from the antenna section 45 to the dummy load, and the dummy load converts the guided microwaves into heat.

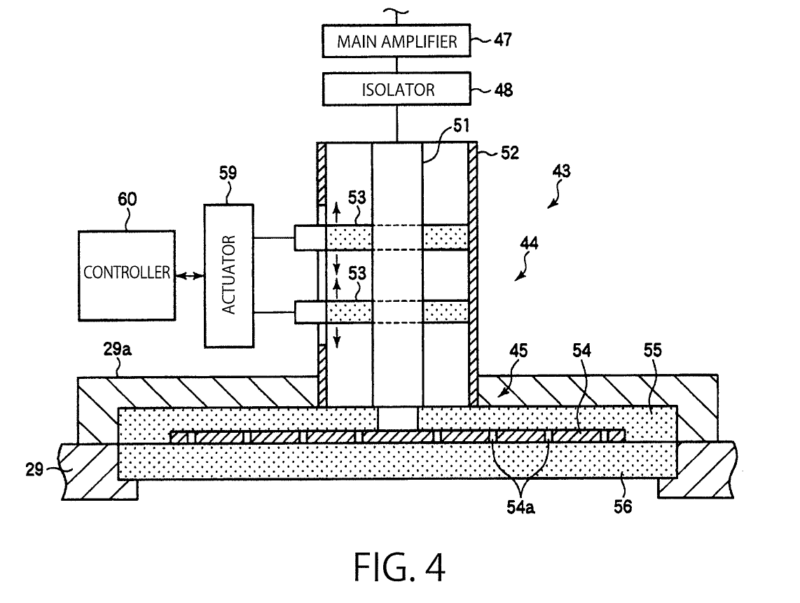

The microwave introduction mechanism 43 will now be described in detail with reference to FIG. 4. As shown in FIG. 4, the microwave introduction mechanism 43 includes the tuner section 44 and the antenna section 45.

The tuner section 44 includes a coaxial tube 50, consisting of an inner conductor 51 and an outer conductor 52, which functions as a microwave transmitting member for transmitting microwaves. Two slugs 53 of dielectric material are slidably provided in the coaxial tube 50. The inner conductor 51 has a cylindrical or rod-like shape, and the outer conductor 52 has a cylindrical shape encircling the inner conductor 51. The slugs 53 each have a plate-like shape, and also have an annular shape having a central hole into which the inner conductor 51 is inserted. Based on a command from a controller 60, an actuator 59 vertically moves the slugs 53 to adjust the impedance. The controller 60 executes the impedance adjustment so as to control the terminal impedance e.g. at 50Ω. When moving only one of the two slugs, the impedance describes a trajectory on a Smith Chart from the origin. When moving the two slugs simultaneously, only the phase rotates. Thus, the tuner section 44 constitutes a slug tuner.

In the coaxial tube 50 constituting a microwave transmitting member, the space between the inner conductor 51 and the outer conductor 52 serves as a microwave transmission path. Based on the relationship between the size of the microwave transmission path and cutoff wavelength, the size of the microwave transmission path is adjusted so that the path transmits only TEM waves without transmitting TE waves and TM waves.

The antenna section 45 includes a plane antenna 54 having a plurality of slots 54a for radiating microwaves. The inner conductor 51 is connected to the central portion of the plane antenna 54. The antenna section 45 also includes a retardation member 55 provided on the upper surface of the plane antenna 54, and a ceiling plate 56 of dielectric material provided on the lower surface of the plane antenna 54. The retardation member 55, the ceiling plate 56 and the plane antenna 54 constitute an electromagnetic wave radiation source which radiates electromagnetic waves into a plasma. The plasma has a particular impedance depending on the plasma state, whereby part of the electromagnetic waves radiated from the electromagnetic wave radiation source are reflected from the plasma and returned to the antenna. Energy loss due to the reflection can be eliminated and the maximum electromagnetic wave energy can be made to be absorbed in the plasma by adjusting the tuner section 44 so that resonance will occur between the tuner section 44 and the plasma.

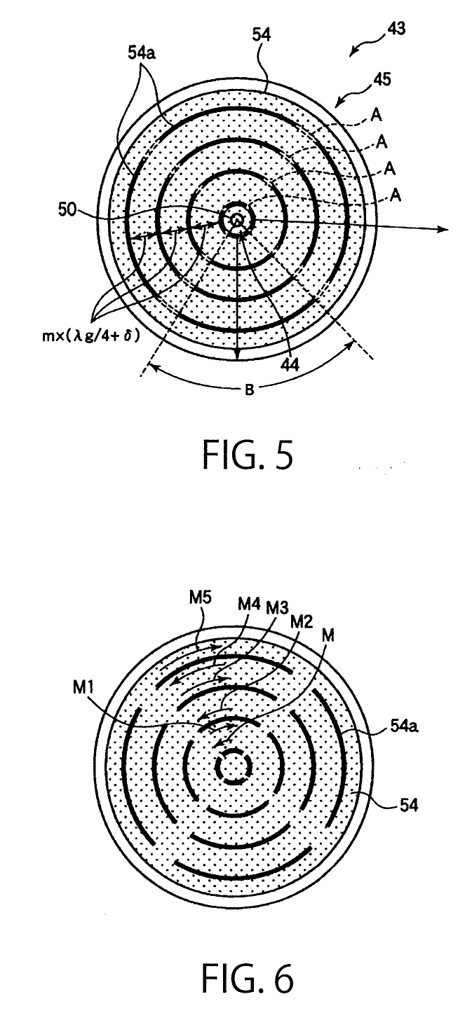

As shown in FIG. 5, the slots 54a are formed in the plane antenna 54 such that when a plurality of (e.g. four as shown) of imaginary concentric circles A, arranged at a spacing equal to an integral multiple (m-fold) of “λg/4+δ” (wherein λg represents the effective wavelength of microwaves, and δ is a value that falls within the range 0≦δ≦0.05λg), e.g. 3×(λg/4+δ), are drawn on the plane of the plane antenna 54, four arc-shaped slots 54a having the same length are evenly arranged on each imaginary circle. The number of slots 54a on each imaginary circle is not limited to four, and may be any integer not less 2 insofar as the slots 54a are evenly arranged on each imaginary circle. Further, as can be seen in FIG. 5, all the microwave radiating slots 54a form four (the same number as the number of slots 54a on each imaginary circle) groups; and slots 54a, belonging to each group, have the same opening angle B and the same angular position, and are arranged in the radial direction. The term “opening angle B” of a slot 54a herein refers to the angle formed between two straight lines drawn from the center of the imaginary concentric circles A, i.e. the center of the plane antenna 54, to the two ends of the slot 54a, in other words, the central angle of the arc on which the slot 54a extends. The term “angular position” refers to the θ coordinate of an r−θ coordinate system as set on the plane of the plane antenna 54 with the center of the imaginary circles A as the origin. Thus, the expression “slots have the same angular position” means that the slots have the same θ coordinates at both ends. In the embodiment shown in FIG. 5, the opening angle B is 83.6° for all the slots 54a, and the total number of the slots 54a is 16 (=4×4).

As shown in FIG. 6, microwaves (electromagnetic waves) are transmitted from the center toward the periphery of the plane antenna 54 by the mutual induction effect of the magnetic field induced by TM01 waves. Thus, based on the magnetic field M formed in the central portion of the plane antenna 54, outer induced magnetic fields M1, M2, M3 . . . , are formed one after another by the mutual induction effect, whereby microwaves are transmitted.

The retardation member 55, provided on the upper surface of the plane antenna 54, has a higher dielectric constant than that of vacuum, and is made of, for example, quartz, a ceramic material, a fluorine-containing resin such as polytetrafluoroethylene, or a polyimide resin. The retardation member 55 functions to make the wavelength of microwaves shorter than that in vacuum, thereby adjusting a plasma. The retardation member 55 can adjust the phase of microwaves by its thickness; and the thickness of the retardation member 55 is adjusted to make the position of the boundary between the retardation member 55 and the plane antenna 54 coincide with the antinode of a standing wave, thereby maximizing the standing wave.

The ceiling plate 56, provided on the lower surface of the plane antenna 54, functions as a vacuum seal and also functions to radiate microwaves. The ceiling plate 56 is made of a dielectric material, such as quartz or a ceramic material.

Thus, microwaves (electromagnetic waves), amplified by the main amplifier 47, are transmitted as TEM waves through the microwave transmission path between the inner conductor 51 and the outer conductor 52. The microwaves are then transmitted from the center to the periphery of the plane antenna 54 by the mutual induction effect of the magnetic field induced by TM01 waves, and radiated from the slots 54a of the plane antenna 54 into the chamber 1 through the ceiling plate 56. The main amplifier 47, the tuner section 44 and the plane antenna 54 are disposed in proximity; the tuner section 44 and the plane antenna 54 constitute a lumped parameter circuit existing in a ½ wavelength area.

The components of the plasma processing apparatus 100 are controlled by a control section 70 including a microprocessor. The control section 70 includes a storage unit in which process recipes are stored, an input means, a display, etc., and controls the plasma processing apparatus in accordance with a selected recipe.

The operation of the plasma processing apparatus 100 having the above-described construction will now be described. First, a wafer W is carried into the chamber 1 and placed on the susceptor 11. While supplying a plasma gas, such as Ar gas, from the plasma gas supply source 27 into the chamber 1 via the piping 28 and the plasma gas introduction member 26, microwaves are introduced from the microwave plasma source 2 into the chamber 1 to form a plasma.

Next, a processing gas, e.g. an etching gas such as Cl₂ gas, from the processing gas supply source 25 is supplied through the piping 24 and ejected from the shower plate 20 into the chamber 1. The ejected processing gas is excited by the plasma that has passed through the space portions 23 of the shower plate 20, whereby the processing gas is turned into plasma. Plasma processing, e.g. etching, of the wafer W is carried out with the thus-formed plasma of the processing gas.

Upon the processing, in the microwave plasma source 2, the microwaves generated by the microwave oscillator 32 of the microwave output section 30 are amplified by the main amplifier 47 of the antenna unit 40, tuned by the tuner section 44 of the microwave introduction mechanism 43, and radiated into the chamber 1 from the plane antenna 54 of the antenna section 45.

As described above, the slugs 53 for impedance matching are provide in the microwave transmission path connected to the plane antenna 54 and, in addition, the plane antenna 54 and the tuner section 44 constituting a slug tuner are disposed in close proximity to each other without interposing any other member between them. This can reduce power loss between the plane antenna 54 and the tuner section 44.

Further, as described above, the plane antenna 54 has a plurality of arc-shaped slots 54a for radiating microwaves, formed such that, assuming that a plurality of imaginary concentric circles A (see FIG. 5), arranged at a spacing equal to an integral multiple of “λg/4+δ” (wherein λg represents the effective wavelength of microwaves, and δ is a value that falls within the range 0≦δ≦0.05 λg), are drawn on the plane of the plane antenna 54, four (integer not less than 2) slots 54a having the same length are evenly arranged on each imaginary circle, and that the plurality of slots 54a form four (integer not less than 2) groups; and slots 54a, belonging to each group, have the same central angle and the same angular position, and are arranged in the radial direction. According to the plane antenna 54, reflected waves from the slots 54a can act to strengthen a standing wave, enabling highly-efficient power radiation from the plane antenna and highly-uniform electric field intensity.

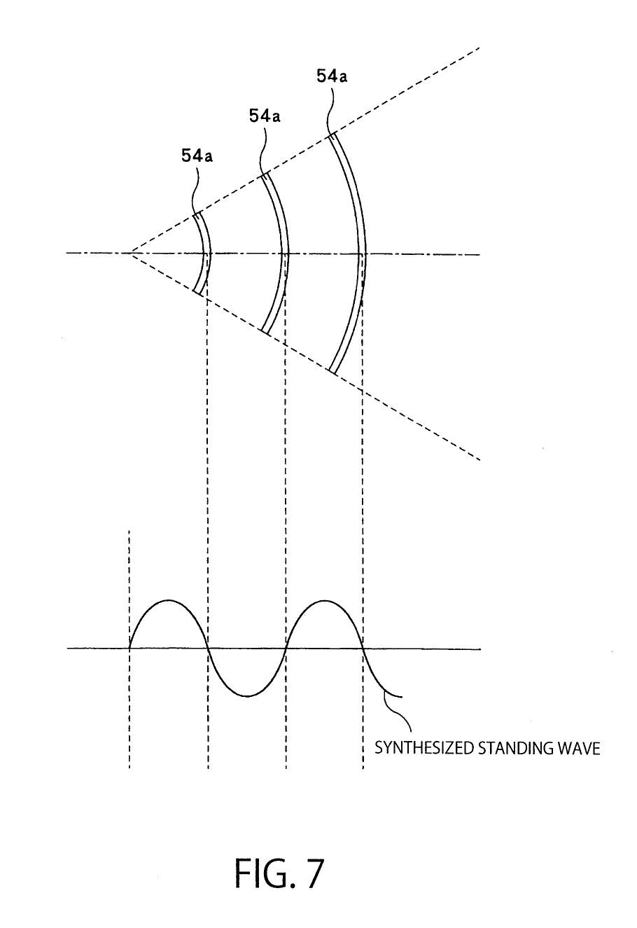

In this regard, as shown in FIG. 7, when the spacing of the slots 54a is equal to an integral multiple of “λg/4+δ”, reflected waves from the slots 54a act to strengthen incident waves being transmitted in the plane antenna 54. The standing wave, synthesized from such waves, therefore has a large amplitude, enabling highly-efficient power radiation. Further, by arranging the slots 54a in the above-described manner, the slots can be arranged evenly, leading to good uniformity of electric field intensity.

Further, the retardation member 55 can adjust the phase of microwaves by its thickness; and the reflection of electromagnetic waves from the plasma can be minimized and the radiated energy from the plane antenna 54 can be maximized by adjusting the thickness of the retardation member 55 so that the position of the plane antenna 54 coincides with the antinode of a standing wave.

Further, the plane antenna 54 is designed to transmit electromagnetic waves from the center toward the periphery of the plane antenna 54 by the mutual induction effect of the magnetic field induced by TM01 waves. This, in principle, makes it possible to increase the antenna size to any desirable one. In particular, as shown in FIG. 6, induced magnetic fields are formed in the slots 54a by the mutual induction effect of TM01 waves in the following manner: Outside the central magnetic field M is formed a reversely-directed induced magnetic field M1, and a reversely-directed induced magnetic field M2 is formed outside the magnetic field M1. Similarly, induced magnetic fields M1, M2, M3 . . . , are formed one after another, whereby microwaves are transmitted. Such microwave transmitting mechanism enables increase of the antenna size.

Further, in the coaxial tube 50 constituting a microwave transmitting member, the size of the microwave transmission path between the inner conductor 51 and the outer conductor 52 is adjusted so that the path transmits only TEM waves without transmitting TE waves and TM waves. This enables easy impedance adjustment. In particular, one impedance matching operation can perform impedance matching in only one of TE-wave, TM-wave and TEM-wave modes. Thus, when two or more of TE waves, TM waves and TEM waves co-exist in microwaves, it is difficult to sufficiently perform impedance matching by one matching operation. In contrast, when only TEM waves are allowed to be transmitted as in this embodiment, impedance matching can be performed by one matching operation.

Another embodiment of the present invention will now be described. It is possible that the electric field intensity in the central portion of the plane antenna 54 may be higher than that in the other portion when the inner conductor 51, constituting the coaxial tube 50 of the tuner section 44, is simply connected to the plane antenna 54 as in the above-described embodiment.

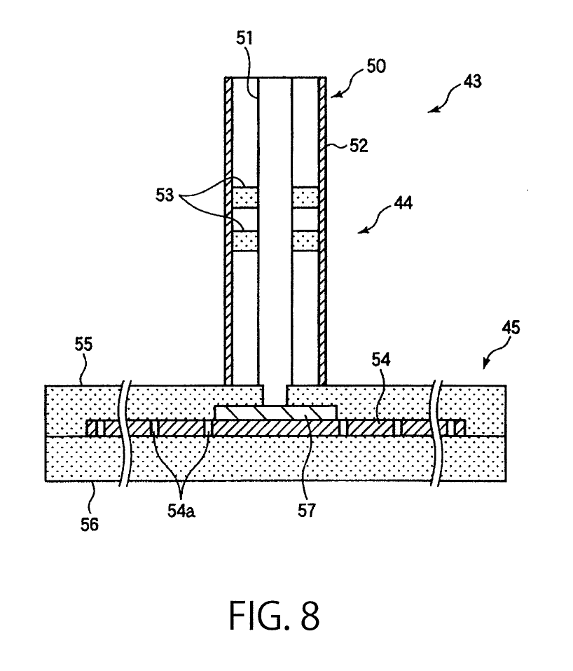

In this embodiment, as shown in FIG. 8, a disk-shaped power diffusing member 57 is provided at the joint between the inner conductor 51 and the plane antenna 54. This makes it possible to outwardly diffuse the electric field intensity of the central portion of the plane antenna 54, thereby further enhancing the in-plane uniformity of electric field intensity.

The power diffusing member 57 is a good conductor and, with its power diffusing effect, can prevent a local rise of electric field intensity in the central portion of the plane antenna 94.

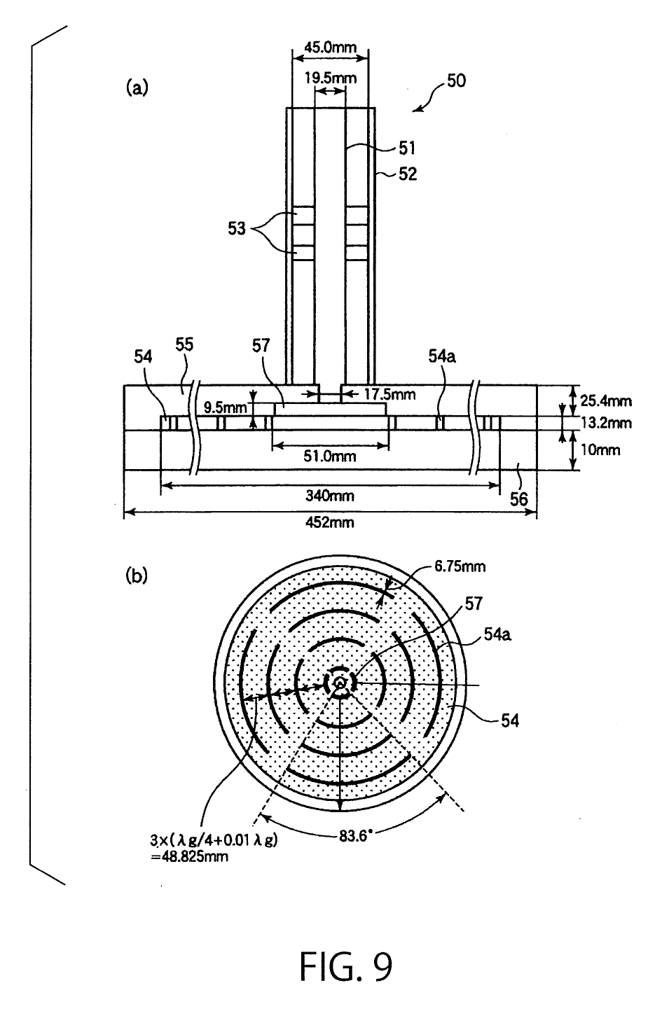

A specific example of the design of a microwave introduction mechanism according to the present invention will now be described with reference to FIGS. 9A and 9B. This design example is for a 300-mm wafer. This example uses microwaves having a frequency of 2.45 GHz and a quartz retardation member 55 (dielectric constant 3.88). Therefore, the effective wavelength λg is 62 mm.

The outer diameter of the inner conductor 51 of the coaxial tube 50 which is a microwave transmitting member is 195 mm, and the inner diameter of the outer conductor 52 is 45 mm. Therefore, the width of the microwave transmission path is 12.75 mm, which allows transmission of only TEM waves.

A circular copper plate having a diameter of 340 mm and a thickness of 13.2 mm is used as the plane antenna 54. The slots 54a are formed such that they are arranged on four imaginary concentric circles, with the spacing of the slots (spacing of the imaginary circles) being 3×(λg/4+0.01λg)=48.825 mm. Each slot 54a has an opening angle B of 83.6° and a width of 6.75 mm.

The quartz retardation member 55 is a circular plate having a diameter of 452 mm and a thickness of 25.4 mm. Like the retardation member, the ceiling plate 56 is a circular quartz plate having a diameter of 452 mm and a thickness of 10 mm. A circular plate having a diameter of 51.0 mm and a thickness of 9.5 mm is used as the power diffusing member.

The microwave radiation of the thus-designed microwave introduction mechanism was simulated. As a result, the electromagnetic field intensity was found to be uniformly distributed over the antenna surface and a region just under the antenna.

The present invention is not limited to the embodiments described above, but is capable of various changes or modifications within the scope of the inventive concept as expressed herein. For example, the circuit constructions of the microwave output section 30, the antenna unit 40 and the main amplifier 47 are not limited to those described above.

Though in the above-described embodiments an etching apparatus is used as a plasma processing apparatus, the present invention is also applicable to other types of plasma processing apparatuses, such as a film-forming apparatus, an oxynitridation processing apparatus, an ashing apparatus, etc. Further, not only a semiconductor wafer but other types of substrates, such as an FPD (flat panel display) substrate as typified by an LCD (liquid crystal display) substrate, a ceramic substrate, etc., can also be used as a processing object.

1. A microwave introduction mechanism for introducing microwaves, outputted from a microwave output section, into a chamber and for use in a microwave plasma source for forming microwaves in the chamber, comprising:
an antenna section including a plane antenna for radiating microwaves into the chamber;
a microwave transmitting member having a coaxial structure, connected to the plane antenna, for guiding microwaves to the plane antenna; and
an impedance adjustment section, provided in the microwave transmitting member, for performing impedance adjustment,
wherein the impedance adjustment section includes a pair of slugs of dielectric material which are movable along the microwave transmitting member, and
wherein the plane antenna has a plurality of arc-shaped slots for radiating microwaves, formed such that, assuming that a plurality of imaginary concentric circles, arranged at a spacing equal to an integral multiple of “λg/4+δ” (wherein λg represents the effective wavelength of microwaves, and δ is a value that falls within the range 0≦δ≦0.05λg), are drawn on a plane of the plane antenna, “n” (n is an integer not less than 2) arc-shaped slots having the same length are evenly arranged on each imaginary circle, and the plurality of arc-shaped slots form “n” groups where the slots belonging to each group arranged in a radial direction and have the same central angle and the same angular position.

2. The microwave introduction mechanism according to claim 1, wherein the antenna section includes a ceiling plate of a dielectric material which is transmissive to microwaves radiated from the plane antenna, and a retardation member of a dielectric material, provided on an opposite side of the plane antenna from the ceiling plate, for shortening the wavelength of microwaves which are to reach the plane antenna.

3. The microwave introduction mechanism according to claim 1, wherein the microwave transmitting member has a microwave transmission path whose size is adjusted to transmit only TEM waves without transmitting TE waves and TM waves.

4. The microwave introduction mechanism according to claim 1, wherein the microwave transmitting member includes a cylindrical or rod-like inner conductor connected to the plane antenna, and a cylindrical outer conductor concentrically provided outside the inner conductor, with the microwave transmission path being formed between the inner conductor and the outer conductor.

5. The microwave introduction mechanism according to claim 4, further comprising a power diffusing member provided at an joint between the inner conductor and the plane antenna.

6. The microwave introduction mechanism according to claim 1, wherein the plane antenna is configured such that electromagnetic waves are transmitted from a center toward a periphery of the plane antenna by mutual induction effect of a magnetic field induced by TM01 waves.

7. The microwave introduction mechanism according to claim 1, wherein the impedance adjustment section and the plane antenna function as a resonator.

8. A microwave plasma source for introducing microwaves into a chamber to turn a gas, supplied into the chamber, into plasma, comprising a microwave generation mechanism for generating microwaves and a microwave introduction mechanism for introducing the generated microwaves into the chamber, wherein the microwave introduction mechanism includes:
an antenna section including a plane antenna for radiating microwaves into the chamber;
a microwave transmitting member having a coaxial structure, connected to the plane antenna, for guiding microwaves from the microwave generation mechanism to the plane antenna; and
an impedance adjustment section, provided in the microwave transmitting member, for performing impedance adjustment,
wherein the impedance adjustment section includes a pair of slugs of dielectric material which are movable along the microwave transmitting member, and
wherein the plane antenna has a plurality of arc-shaped slots for radiating microwaves, formed such that, assuming that a plurality of imaginary concentric circles, arranged at a spacing equal to an integral multiple of “λg/4+δ” (wherein λg represents the effective wavelength of microwaves, and δ is a value that falls within the range 0≦δ≦0.05λg), are drawn on a plane of the plane antenna, “n” (n is an integer not less than 2) arc-shaped slots having the same length are evenly arranged on each imaginary circle, and the plurality of arc-shaped slots form “n” groups where the slots belonging to each group are arranged in a radial direction and have the same central angle and the same angular position.

9. A microwave plasma processing apparatus comprising a chamber for housing the substrate, a gas supply mechanism for supplying a gas into the chamber, and a microwave plasma source for introducing microwaves into the chamber to turn the gas, supplied into the chamber, into a plasma, the microwave plasma source including a microwave generation mechanism for generating microwaves and a microwave introduction mechanism for introducing the generated microwaves into the chamber, said microwave plasma processing apparatus being configured to processing a substrate with the plasma in the chamber, wherein the microwave introduction mechanism includes:
an antenna section including a plane antenna for radiating microwaves into the chamber;
a microwave transmitting member having a coaxial structure, connected to the plane antenna, for guiding microwaves from the microwave generation mechanism to the plane antenna; and
an impedance adjustment section, provided in the microwave transmitting member, for performing impedance adjustment,
wherein the impedance adjustment section includes a pair of slugs of dielectric material which are movable along the microwave transmitting member, and
wherein the plane antenna has a plurality of arc-shaped slots for radiating microwaves, formed such that, assuming that a plurality of imaginary concentric circles, arranged at a spacing equal to an integral multiple of “λg/4+δ” (wherein λg represents the effective wavelength of microwaves, and δ is a value that falls within the range 0≦δ≦0.05λg), are drawn on a plane of the plane antenna, “n” (n is an integer not less than 2) arc-shaped slots having the same length are evenly arranged on each imaginary circle, and the plurality of arc-shaped slots form “n” groups where the slots belonging to each group are arranged in a radial direction and have the same central angle and the same angular position.
